(19) United States
(12) Patent Application Publication
(10) Pub. No.: US 2010/0325899 A1
(43) Pub. Date: Dec. 30, 2010

(54) RETRACTABLE UTILITY KNIFE

(76) Inventors: Brett P. Seber, Escondido, CA (US); Wesley J. Tom, Escondido, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/822,250

(22) Filed: Jun. 24, 2010

Related U.S. Application Data
(60) Provisional application No. 61/220,079, filed on Jun. 24, 2009.

(51) Int. Cl. B26B 5/00; B26B 1/08

(52) U.S. Cl. 30/162; 30/337

(57) ABSTRACT

The present invention generally relate to a retractable utility knife. In one aspect, a knife is provided. The knife comprising a handle and a utility blade having a top edge, a bottom edge, a first side edge and a second side edge. The knife further comprising a blade holder having a lock assembly for holding the utility blade within the blade holder, wherein the lock assembly is movable between a blade lock position and a blade release position and wherein the lock assembly includes a lock member that engages the first side edge in the blade lock position.

### CROSS-REFERENCE TO RELATED APPLICATIONS

This application claims benefit of U.S. provisional patent application Ser. No. 61/220,079, filed Jun. 24, 2009, which is herein incorporated by reference.

### BACKGROUND OF THE INVENTION

1. Field of the Invention

Embodiments of the present invention generally relate to a retractable utility knife. More particularly, embodiments of the present invention relate to a blade lock assembly for use with a retractable utility knife.

2. Description of the Related Art

A conventional utility knife typically includes a blade holder that is movable relative to a handle of the utility knife. The blade holder is used to hold the blade and the blade holder allows the user to manually adjust how far the blade extends from the handle. The blade holder in the conventional utility knife typically includes a protrusion that engages a notch in the blade in order to secure (or lock) the blade to the blade holder. Even though the protrusion may be an effective means to lock the blade to the blade holder, there is a need for an improved blade lock assembly for a blade holder of the utility knife.

### SUMMARY OF THE INVENTION

The present invention generally relates to a retractable utility knife. In one aspect, a utility knife is provided. The utility knife comprises a handle and a utility blade having a top edge, a bottom edge, a first side edge, and a second side edge. The utility knife further comprises a blade holder having a lock assembly for holding the utility blade within the blade holder, wherein the lock assembly is movable between a blade lock position and a blade release position and wherein the lock assembly includes a lock member that engages the first side edge of the blade in the blade lock position.

In another aspect, a retractable knife is provided. The retractable knife comprises a handle including a first plate and a second plate, wherein the plates are separated from each other such that the handle includes a front aperture and wherein the handle includes at least one protrusion that defines a portion of the front aperture. The retractable knife further comprises a utility blade. Additionally, the retractable knife comprises a blade holder configured to hold the blade, wherein the blade holder is movable relative to the handle between an extended position and a retracted position.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are views illustrating a knife having a blade holder in a retracted position and an extended position.

FIG. 2 is a top view of the knife with the blade holder in the extended position.

FIG. 3A is a view of the blade holder when a blade lock assembly is in the lock position.

FIG. 3B is a view of the blade holder when the blade lock assembly is in the release position.

FIG. 3C is a side view of the blade lock assembly.

FIG. 3D is a view illustrating a blade lock assembly according to one embodiment of the invention.

FIG. 4 is a view illustrating the knife with a blade lock assembly according to one embodiment of the invention.

FIGS. 5A-5F are views illustrating the knife with a blade lock assembly according to one embodiment of the invention.

FIG. 6 is an exploded view of a handle of the knife according to one embodiment of the invention.

FIGS. 7A-7C are views illustrating a handle of the knife according to one embodiment of the invention.

FIGS. 8A and 8B are views illustrating a handle of the knife according to one embodiment of the invention.

FIG. 9 is a view illustrating a handle of the knife according to one embodiment of the invention.

FIG. 10 is a view illustrating a handle of the knife according to one embodiment of the invention.

FIG. 11 is a view illustrating a handle of the knife according to one embodiment of the invention.

### DETAILED DESCRIPTION

The present invention generally relates to a retractable utility knife. To better understand the novelty of the present invention and the methods of use thereof, reference is hereafter made to the accompanying drawings.

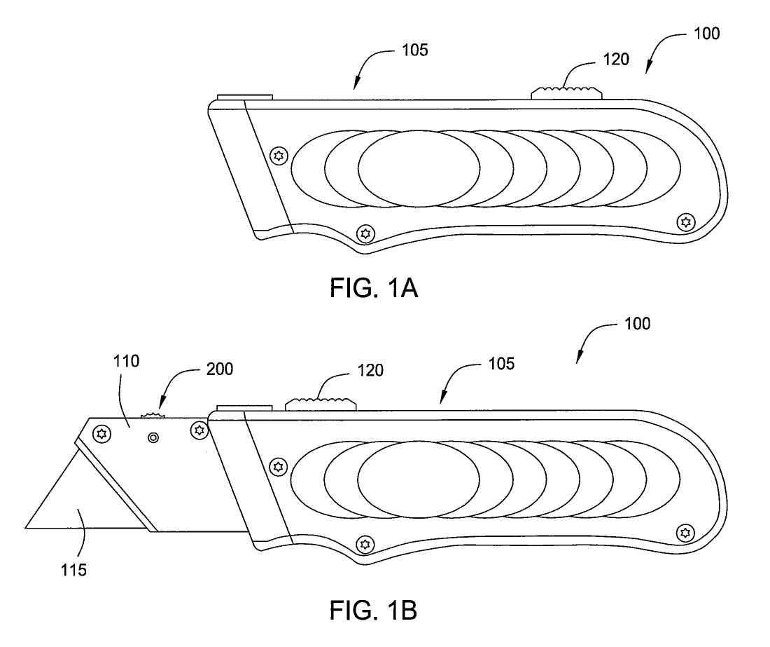

FIGS. 1A and 1B are views illustrating a knife 100 having a blade holder 110 in a retracted position and an extended position. The blade holder 110 is movable between the retracted and the extended position by manipulating a button 120 on an upper portion of the knife 100. In the extended position, a blade 115 extends from a handle 105 of the knife 100. In the retracted position, the blade 115 is disposed within the handle 105 of the knife 100.

The blade holder 110 is configured to hold a portion of the blade 115. Further, the blade holder 110 is configured to move the blade 115 relative to the handle 105 as the blade holder 110 moves between the retracted position and the extended position. The blade holder 110 is connected to the button 120. Generally, the button 120 is used to move the blade holder 110 relative to the handle 105. The button 120 is also used to lock the blade holder 110 in the retracted position and the extended position.

The blade holder 110 includes a blade lock assembly 200 that holds the blade 115 in the blade holder 110. The blade lock assembly 200 is movable between a lock position and a release position. In the lock position, the blade 115 is secured (or locked) to the blade holder 110. In the release position, the blade 115 may be removed from the blade holder 110 and subsequently replaced by another blade.

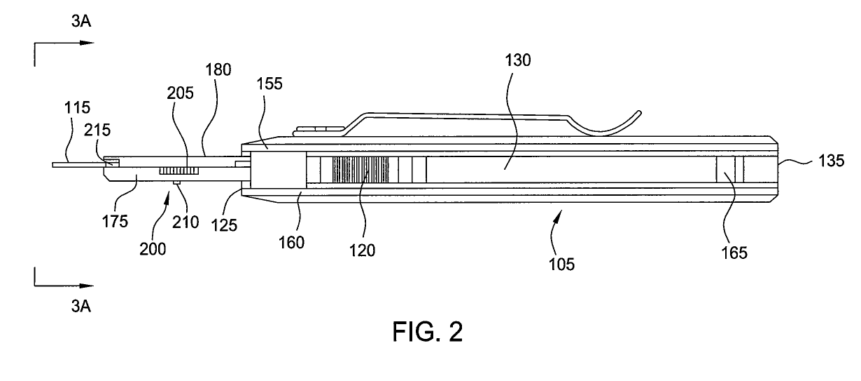

FIG. 2 is a top view of the knife 100 with the blade holder 110 in the extended position. As illustrated, the handle 105 is formed from a first plate 155 and a second plate 160. The first plate 155 is separated from the second plate 160 by a plurality of spacer members 165. The handle 105 includes a front slot 125, a top slot 130, a rear slot 135 and a bottom slot (not shown). It is to be noted that each slot defines an opening or aperture in the handle 105. In one embodiment, the blade 115 extends through the front slot 125 (or aperture) of the handle 105 when the knife 100 is in the extended position. In another embodiment, the blade holder 110 and the blade 115 extends through the front slot 125 (or aperture) of the handle 105 when the knife 100 is in the extended position. The button 120 extends from the top slot 130 (or aperture) of the handle 105 and the button 120 slides along the top slot 130 as the blade holder 110 moves between the retracted and extended position.

The blade holder 110 includes a plate 180 and a cover plate 175. The cover plate 175 is attached to the plate 180 such that the blade holder 110 covers a portion of a first side and a second side of the blade 115. In one embodiment, the side plate 180 and the cover plate 175 have different thicknesses. In this embodiment, the blade 115 is offset from a longitudinal axis of the handle 105. As a result, the blade 115 may be spaced closer to one edge of the front slot (or aperture) 125 than another edge of the front slot (or aperture) 125. For instance, the blade 115 may be spaced from one edge of the aperture by less than 1 mm.

The blade holder 110 includes the blade lock assembly 200 that holds the blade 115 in the blade holder 110. The blade lock assembly 200 includes a biasing member 215 and a wheel 205 that rotates on a shaft member 210. As the wheel 205 is rotated, the blade lock assembly 200 moves between the lock position and the release position.

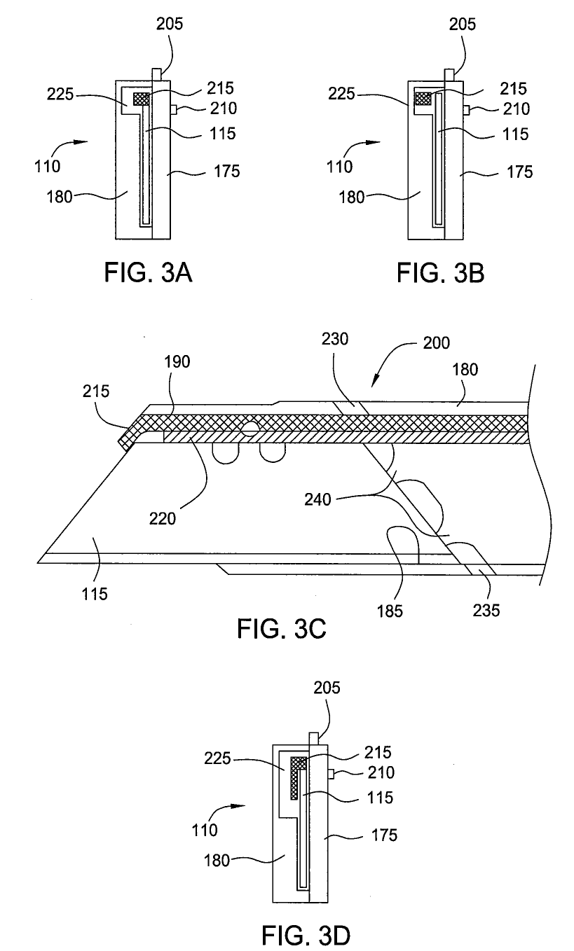

FIG. 3A is a view of the blade holder 110 when the blade lock assembly 200 is in the lock position and FIG. 3B is a view of the blade holder 110 when the blade lock assembly 200 is in the release position. For clarity, the handle 105 is not shown in FIGS. 3A and 3B. As shown in FIG. 3A, the blade lock assembly 200 includes the biasing member 215, such as a leaf spring. When the blade lock assembly 200 is in the lock position (FIG. 3A), the biasing member 215 is engaged with a front leading edge of the blade 115 such that the blade 115 is secured within the blade holder 110. In one embodiment, the front leading edge is at least 40 degrees. When the blade lock assembly 200 is in the release position (FIG. 3B), the biasing member 215 is substantially disengaged with the blade 115 such that the blade 115 may be removed from the blade holder 110. It is to be noted that that blade lock assembly 200 is biased in the lock position. In other words, the biasing member 215 is biased toward the blade 115 such that the biasing member 215 engages the blade 115 as shown in FIG. 3A.

To move the blade lock assembly 200 from the lock position to the release position, the wheel 205 is rotated in a first direction such that a cam (not shown) on the wheel 205 is moved into engagement with the biasing member 215. The cam is configured to urge the biasing member 215 away from the blade 115 and into a pocket 225 in the plate 180. At this point, the blade 115 may be removed from the blade holder 110 and subsequently replaced with another blade. After the blade is placed in the blade holder 110, the wheel 205 may be rotated in a second direction such that the cam is moved out of engagement with the biasing member 215, thereby allowing the biasing member 215 to move out of the pocket 225 and engage the blade 115. In one embodiment, the biasing member 215 has at least a 40-degree locking face with the blade 115.

FIG. 3C is a side view of the blade lock assembly 200. For clarity, the cover plate 175, the wheel 205 and shaft 210 are not shown. As illustrated in FIG. 3C, the plate 180 includes a blade pocket defined by a lower shoulder 185, an upper member 220 and back support shoulders 240. The blade pocket is configured to facilitate the positioning of the blade 115 in the blade holder 110. The plate 180 also includes an upper channel 230 and a lower channel 235 which are configured to allow debris to exit from the blade holder 110. As also shown in the FIG. 3C, the biasing member 215 is engaged with the blade 115. It is to be noted that the blade lock assembly 200 in the embodiment illustrated secures the blade 115 in the blade holder 110 without the use of notches in the blade 115. In another embodiment, the blade lock may be configured to engage the notches in the blade. FIG. 3D is a view illustrating another embodiment of the biasing member 215. As illustrated, the biasing member 215 includes an extension portion that interacts with a side of the blade 115 when the blade lock assembly 200 is in the lock position.

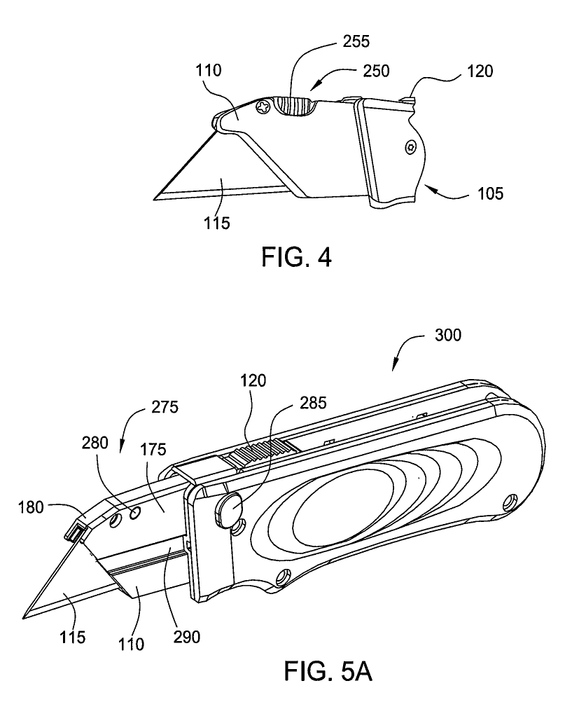

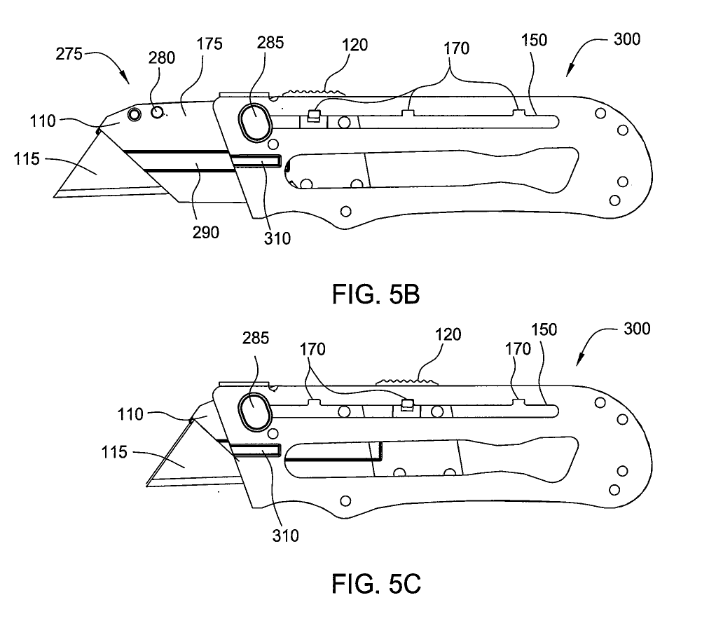

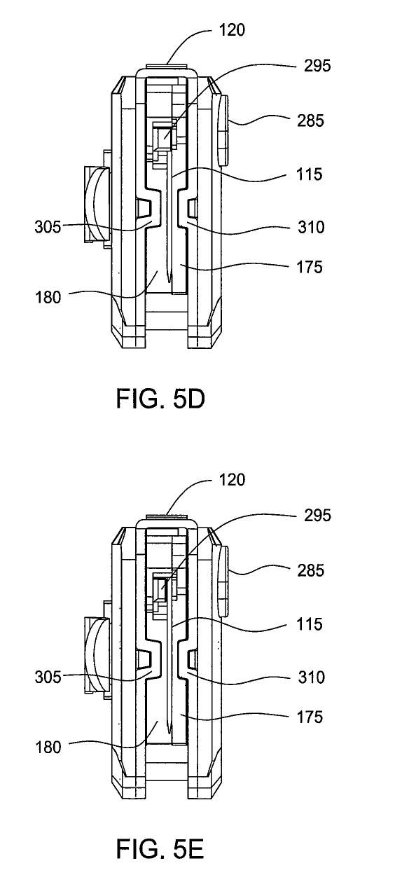

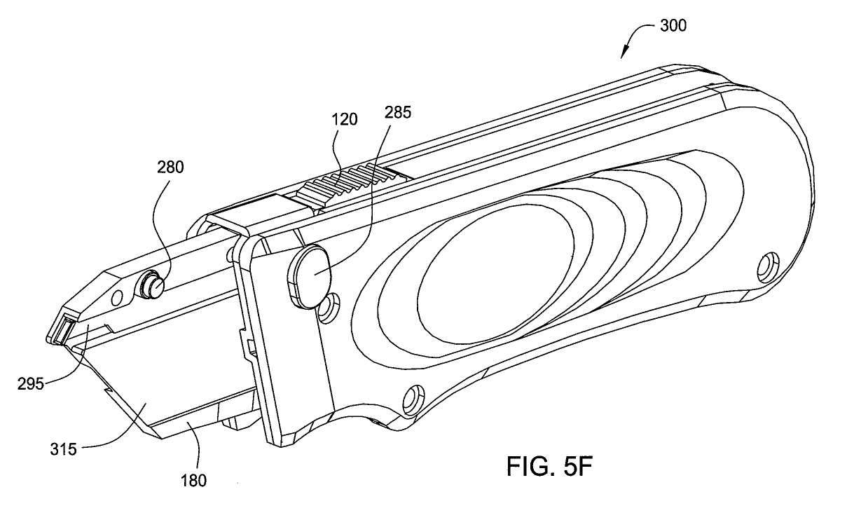

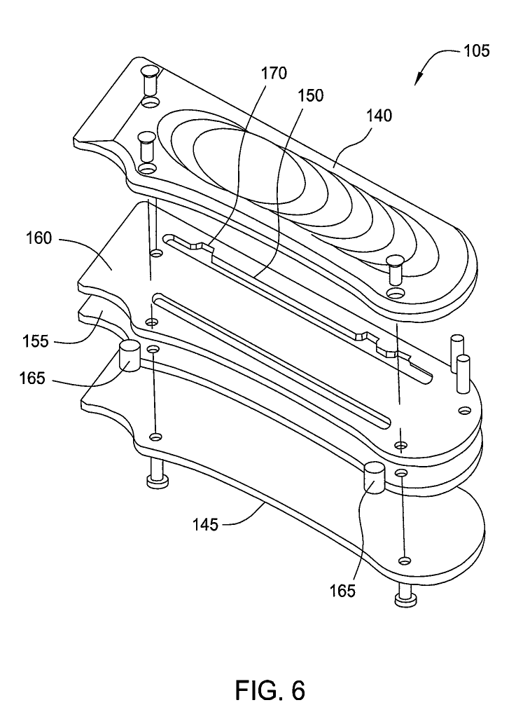

FIG. 4 is a view illustrating the knife 100 with a blade lock assembly 250. The blade lock assembly 250 functions in a similar manner as the blade lock assembly 200. For instance, the blade lock assembly 250 includes a biasing member, such as a leaf spring, similar to the biasing member 295 in FIGS. 5D and 5E. The blade lock assembly 250 is movable between a lock position and a release position. In the lock position, the biasing member is engaged with the blade 115 such that the blade 115 is secured within the blade holder 110. In the release position, the biasing member is substantially disengaged with the blade 115 such that the blade 115 may be removed from the blade holder 110. It is to be noted that that blade lock assembly 250 is biased in the lock position. In other words, the biasing member is biased toward the blade 115 such that the biasing member engages the blade 115 (i.e. lock position).

To move the blade lock assembly 250 from the lock position to the release position, a side button 255 is pushed in a first direction. In the embodiment illustrated in the FIG. 4, the first direction is toward the plate 180. The side button 255 is attached to the biasing member and therefore the movement of the side button 255 in the first direction urges the biasing member away from the blade 115 and into the pocket in the plate 180. At this point, the blade 115 may be removed from the blade holder 110 and subsequently replaced with another blade. It is to be noted that the side button 255 must also be pushed in order to place a new blade in the blade holder 110. After the blade is placed in the blade holder 110, the side button 255 is released and allowed to move in a second direction away from the plate 180, thereby allowing the biasing member to move out of the pocket and engage the blade 115. It is to be noted that since the blade lock assembly 250 is biased in the lock position, the removal of the pushing force applied to the side button 255 automatically causes the side button to move in the second direction. It is also to be noted that the blade lock assembly 250 in the embodiment illustrated secures the blade 115 in the blade holder 110 without the use of notches in the blade 115. In another embodiment, the blade lock may be configured to engage the notches in the blade.

FIGS. 5A-5F are views illustrating the knife 100 with a blade lock assembly 275. The blade lock assembly 275 functions in a similar manner as the blade lock assembly 200. For instance, the blade lock assembly 275 includes the biasing member 295. The blade lock assembly 275 is movable between a lock position (FIG. 5D) and a release position (FIG. 5E) by manipulating a first button 280 on the blade holder 110 and a second button 285 on the handle 105. In the lock position, the biasing member 295 is engaged with the blade 115 such that the blade 115 is secured within the blade holder 110. In the release position, the biasing member 295 is substantially disengaged with the blade 115 such that the blade 115 may be removed from the blade holder 110. It is to be noted that that blade lock assembly 275 is biased in the lock position. In other words, the biasing member 295 is biased toward the blade 115 such that the biasing member 295 engages the blade 115 (i.e. lock position). Further, the second button 285 is biased radially outward from the handle 300 by a biasing member (not shown).

FIGS. 5B and 5C illustrate the knife 100 with the blade holder 110 in the extended position and an intermediate position. For clarity, the covers of the handle have been removed. To move the blade lock assembly 275 from the lock position to the release position, the blade holder 110 is moved from the extended position (FIG. 5B) to the intermediate position (FIG. 5C) by using the button 120. In the intermediate position, the first button 280 on the blade holder 110 is aligned with the second button 285 on the handle 105. At this point, the second button 285 may be pushed in a first direction toward the handle 105. The movement of the second button 285 causes the first button 280 to move in the first direction. The first button 280 is attached to the biasing member 295 and therefore the movement of the first button 280 in the first direction urges the biasing member 295 away from the blade 115 and into the pocket in the plate 180. At this point, the blade 115 may be removed from the blade holder 110 and subsequently replaced with another blade. It is to be noted that the second button 285 must also be pushed in order to place a new blade in the blade holder 110. After the blade is placed in the blade holder 110, the second button 285 is released and allowed to move in a second direction away from the handle 105, thereby allowing the first button 280 to move in the second direction. The movement of the first button 280 allows the biasing member 295 to move out of the pocket and engage the blade 115. It is to be noted that since the blade lock assembly 275 is biased in the lock position, the removal of the pushing force applied to the second button 285 (and the first button 280) automatically causes the second button 285 (and the first button 280) to move in the second direction. It is also to be noted that the blade lock assembly 275 in the embodiment illustrated secures the blade 115 in the blade holder 110 without the use of the notches in the blade 115. In another embodiment, the blade lock may be configured to engage the notches in the blade.

FIG. 5F illustrates the plate 180 of the blade holder 110. For clarity, the plate 175 and the blade 115 have been removed. As shown in FIG. 5F, the plate 180 includes a blade pocket 315 that is configured to facilitate the positioning of the blade 115 in the blade holder 110. As illustrated, the biasing member 295 includes a front tab portion that engages the front leading edge of the blade when the blade lock 275 is in the locked position. In one embodiment, the front tab is at 40-degree angle. The biasing member 295 further includes a side portion that may be used to engage a side of the blade when the blade lock 275 is in the locked position. As also shown, the button 280 is attached to the biasing member 295 and therefore the movement of the button will cause the movement of the biasing member 295.

FIG. 6 is an exploded view of the handle 105. As illustrated, the handle 105 includes the first plate 155, the second plate 160 and the plurality of spacer members 165. The handle 105 also includes a first cover 140 and a second cover 145. The covers 140, 145 are connected to the plates 155, 160 via a plurality of connection members. As also illustrated in FIG. 6, the plate 160 includes a slot 150 having at least two detents 170. The plate 155 includes a corresponding slot with detents (not shown). The slot 150 is configured to interact with pin members (not shown) on the blade holder 110 as the knife 100 moves between the extended position and the retracted position. The detents 170 are configured to interact with the button 120 to lock the blade holder 110 in the extended position and the retracted position.

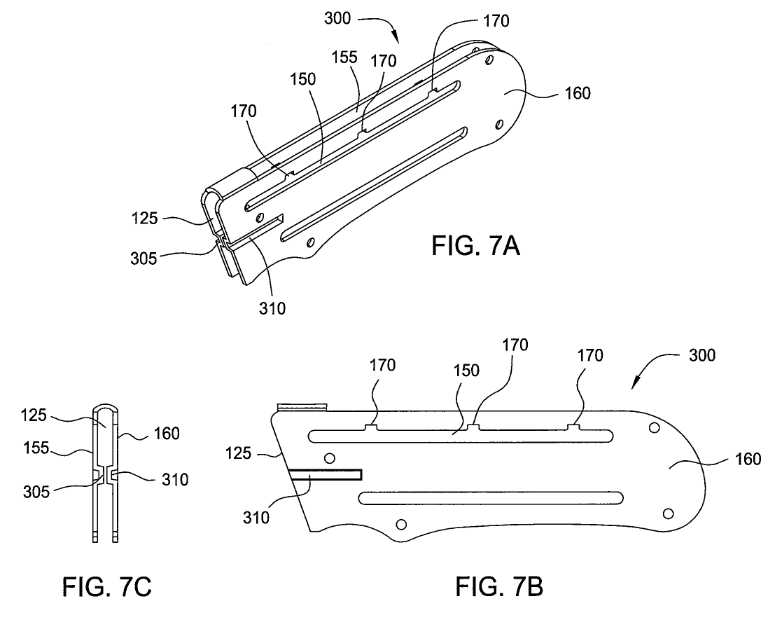

FIGS. 7A-7C are views illustrating a handle 300 according to one embodiment of the invention. For convenience, the components in the handle 300 that are similar to the components in the handle 105 will be labeled with the same reference indicator. Additionally, the first cover and the second cover are not shown for clarity. The handle 300 includes a first protrusion 305 formed in the plate 155 and a second protrusion 310 formed in the plate 160. The protrusions 305, 310 form a portion of the slot (or aperture) 125 and therefore define a portion of a perimeter of the slot (or aperture) 125.

The protrusions 305, 310 may be configured to interact with the blade holder 110. For instance, the protrusions 305, 310 may be configured to interact with corresponding grooves (see groove 290 in FIGS. 5B and 5C) formed in the plates 175, 180 of the blade holder 110. The interaction between the grooves and the protrusions 305, 310 may be used to guide and/or stabilize the blade holder 110 as the blade holder 110 moves between the retracted position and the extended position. Additionally, in one embodiment, the protrusions 305, 310 ensure that the blade 115 is spaced from the perimeter of the slot (or aperture) 125 by less than 1 mm as the blade holder 110 moves between the retracted position and the extended position. Although the handle 300 in FIGS. 7A-7C show two protrusions it should be understood, however, that the handle 300 may include any number of protrusions without departing from principles of the present invention.

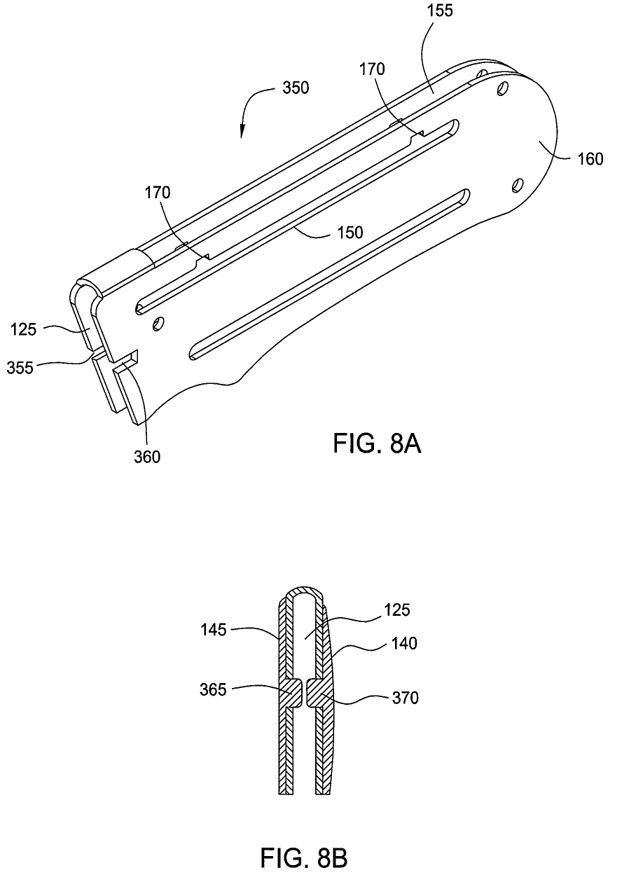

FIGS. 8A and 8B are views illustrating a handle 350 according to one embodiment of the invention. For convenience, the components in the handle 350 that are similar to the components in the handle 105 will be labeled with the same reference indicator. Additionally, the first cover 140 and the second cover 145 are not shown in FIG. 8A for clarity. As shown in FIG. 8A, the handle 300 includes a first cutout 355 in the plate 155 and a second cutout 360 in the plate 160. As illustrated in FIG. 8B, the first cover 140 includes a first tab 370 and the second cover 145 includes a second tab 365. As illustrated, the tabs 365, 370 are disposed in the cutouts 355, 360. The tabs 365, 370 form a portion of the slot (or aperture) 125 and therefore define a portion of a perimeter of the slot (or aperture) 125.

The tabs 365, 370 are configured to interact with corresponding grooves (not shown) formed in the blade holder 110. The interaction between the grooves and the tabs 365, 370 may be used to guide and/or stabilize the blade holder 110 as the blade holder 110 moves between the retracted position and the extended position. Additionally, in one embodiment, the tabs 365, 370 ensure that the blade 115 is spaced from the perimeter of the slot (or aperture) 125 by less than 1 mm as the blade holder 110 moves between the retracted position and the extended position. Although the handle 350 in FIGS. 8A and 8B show two tabs it should be understood, that the handle 350 may include any number of tabs without departing from principles of the present invention.

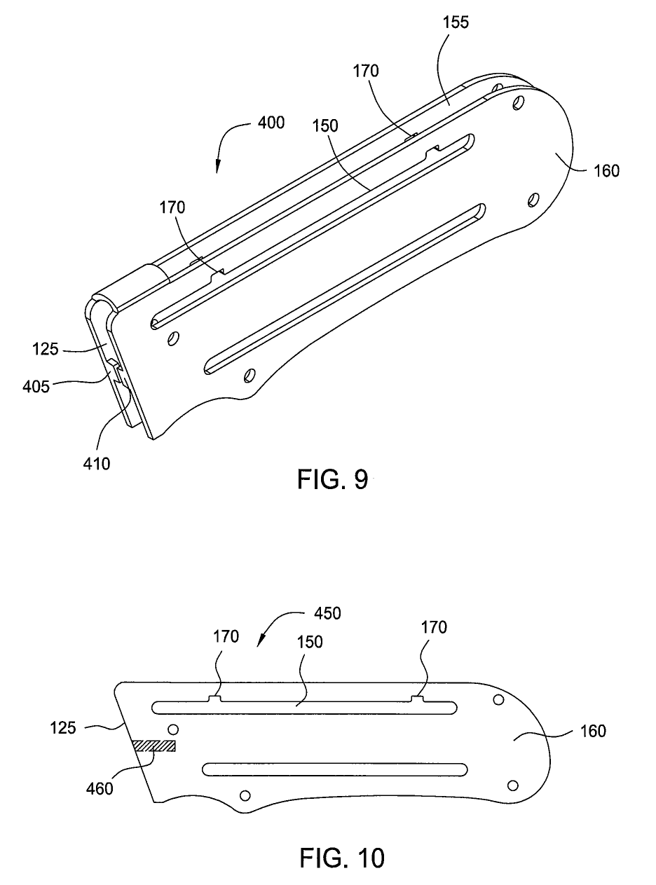

FIG. 9 is a view illustrating a handle 400 according to one embodiment of the invention. For convenience, the components in the handle 400 that are similar to the components in the handle 105 will be labeled with the same reference indicator. Additionally, the first cover and the second cover are not shown for clarity. The handle 400 includes a first tab 405 extending from the plate 155 and a second tab 410 extending from the plate 160. The tabs 405, 410 form a portion of the slot (or aperture) 125 and therefore define a portion of a perimeter of the slot (or aperture) 125. The tabs 405, 410 are configured to interact with corresponding grooves (not shown) formed in the plates 175, 180 in the blade holder 110. This interaction may be used to guide and/or stabilize the blade holder 110 as the blade holder 110 moves between the retracted position and the extended position. In one embodiment, the tabs 405, 410 ensure that the blade 115 is spaced from the perimeter of the slot (or aperture) 125 by less than 1 mm as the blade holder 110 moves between the retracted position and the extended position. Additionally, the handle 400 may have any number of tabs without departing from principles of the present invention.

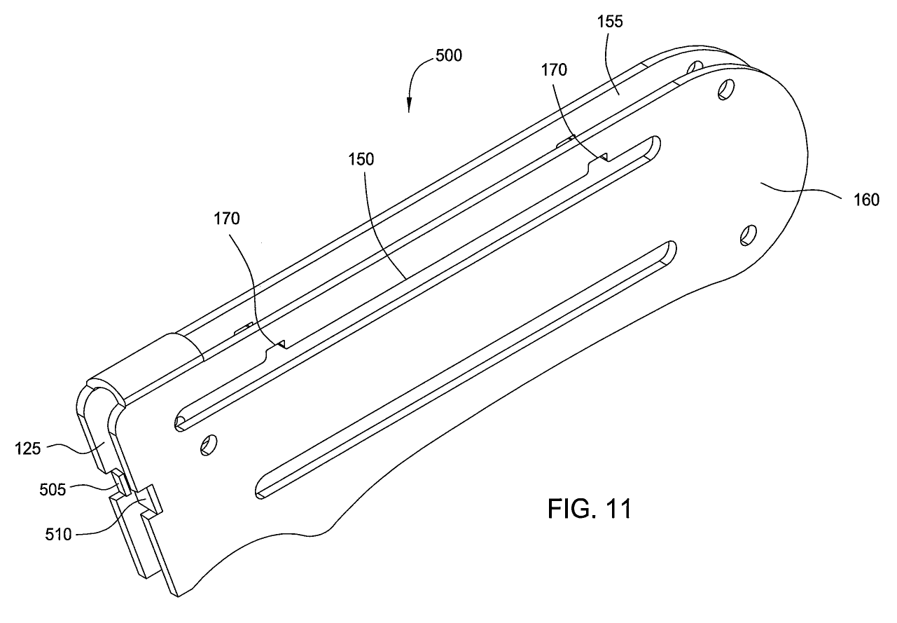

FIG. 10 is a view illustrating a handle 450 according to one embodiment of the invention. For convenience, the components in the handle 450 that are similar to the components in the handle 105 will be labeled with the same reference indicator. Additionally, the first cover and the second cover are not shown for clarity. The handle 450 includes a bar member 460 along an inside surface of the plate 160. A corresponding bar member (not shown) may also be attached along an inside surface of the plate 155. The bar member(s) 460 form a portion of the slot (or aperture) 125 and therefore define a portion of a perimeter of the slot (or aperture) 125. The bar member(s) 460 is configured to interact with the blade holder 110 in order to guide and/or stabilize the blade holder 110 as the blade holder 110 moves between the retracted position and the extended position. In one embodiment, the bar member(s) 460 ensure that the blade 115 is spaced from the perimeter of the slot (or aperture) 125 by less than 1 mm as the blade holder 110 moves between the retracted position and the extended position. Additionally, the handle 450 may have any number of bar members without departing from principles of the present invention.

FIG. 11 is a view illustrating a handle 500 according to one embodiment of the invention. For convenience, the components in the handle 500 that are similar to the components in the handle 105 will be labeled with the same reference indicator. Additionally, the first cover and the second cover are not shown for clarity. The handle 500 includes a first tab 505 in the plate 155 and a second tab 510 in the plate 160. The tabs 505, 510 are configured to interact with corresponding grooves (not shown) formed in the blade holder 110. The interaction of the tabs 505, 510 with the grooves may be used to guide and/or stabilize the blade holder 110 as the blade holder 110 moves between the retracted position and the extended position. Additionally, the handle 500 may have any number of tabs without departing from principles of the present invention.

While the foregoing is directed to embodiments of the present invention, other and further embodiments of the invention may be devised without departing from the basic scope thereof, and the scope thereof is determined by the claims that follow.

1. A utility knife comprising:
a handle;
a utility blade having a top edge, a bottom edge, a first side edge and a second side edge; and
a blade holder having a lock assembly for holding the utility blade within the blade holder, wherein the lock assembly is movable between a blade lock position and a blade release position and wherein the lock assembly includes a lock member that engages the first side edge of the blade in the blade lock position.

2. The knife of claim 1, wherein the lock assembly is biased in the blade lock position.

3. The knife of claim 1, wherein the lock assembly includes a rotatable wheel member that moves the lock assembly between the blade lock position and the blade release position.

4. The knife of claim 1, wherein the lock assembly includes a slidable tab member that moves the lock assembly between the blade lock position and the blade release position.

5. The knife of claim 1, wherein the lock assembly includes a push button that moves the lock assembly between the blade lock position and the blade release position.

6. The knife of claim 5, wherein the push button is configured to be activated when the push button is aligned with a button disposed in the handle.

7. The knife of claim 1, wherein the blade holder includes a blade pocket that is configured to engage a portion of the bottom edge and the top edge of the blade.

8. A retractable knife comprising:
a handle including a first plate and a second plate, wherein the plates are separated from each other such that the handle includes a front aperture and wherein the handle includes at least one protrusion that defines a portion of the front aperture;
a utility blade; and
a blade holder configured to hold the blade, wherein the blade holder is movable relative to the handle between an extended position and a retracted position.

9. The knife of claim 8, wherein a side of the blade is spaced from a perimeter of the aperture by less than 1 mm.

10. The knife of claim 8, wherein the at least one protrusion ensures that the utility blade remains spaced from a perimeter of the front aperture by less than 1 mm as the blade holder slides from the extended position to the retracted position.
